(19) United States
(12) Patent Application Publication
(10) Pub. No.: US 2010/0131863 A1
(43) Pub. Date: May 27, 2010

(54) INCREMENTAL COLLABORATIVE FILTERING

(75) Inventors: Yosef Wexler, Shimshit (IL); Amir Shatz, Zur Igal (IL)

Correspondence Address: D. Kligler I.P. Services LTD, P.O. Box 25, Zippori, 17910, IL

(73) Assignee: MOBIXELL NETWORKS LTD, Ra'anana (IL)

(21) Appl. No.: 12/623,419

(22) Filed: Nov. 22, 2009

Related U.S. Application Data
(60) Provisional application No. 61/118,449, filed on Nov. 27, 2008.

(51) Int. Cl. G06F 3/00

(52) U.S. Cl. 715/753

(57) ABSTRACT

A method for content delivery includes obtaining responses from a first plurality of users to a second plurality of items of content that were delivered to the users over a communication network. For each item, a respective vector is created corresponding to the responses of the users to the item. Distances between the items are computed responsively to the vectors. A first item is selected for delivery to a given user based on a previous response of the given user to a second item and to a distance computed between the first and second items responsively to the vectors. Following the delivery of the first item, upon receiving a response to the first item from the given user, the distances computed between the items are updated based on the response to the first item. The updated distances are applied in selecting a further item for delivery to another user.

### CROSS-REFERENCE TO RELATED APPLICATION

This application claims the benefit of U.S. Provisional Patent Application 61/118,449, filed Nov. 27, 2008, which is incorporated herein by reference.

### FIELD OF THE INVENTION

The present invention relates generally to systems and methods for content distribution, and specifically to methods for individualized targeting of content.

### BACKGROUND OF THE INVENTION

In network-based content distribution, promotional content, such as advertisements, is often pushed to the users. Typically, the advertisements contain hyperlinks, so that the user can respond, if interested, by clicking on the advertisement. The expected click rate is in the range of 1-2% when advertisements are sent randomly. A higher click rate is desirable in order to increase revenues from the advertising process. Methods of targeted advertising attempt to increase user response by matching advertisements to known or inferred user characteristics.

Recommendation systems apply knowledge discovery techniques in order to make personalized recommendations for delivery of certain content during an interaction with a given user. One technique that may be used for this purpose is collaborative filtering. This techniques works by building a database of preferences for items by users. A given user is matched against the database to discover “neighbors”—other users who have historically had similar taste to the given user. Items that the neighbors have liked are then recommended to the given user. Techniques of this sort are described, for example, by Sarwar et al., in “Item-Based Collaborative Filtering Recommendation Algorithms,” Proceedings of the World Wide Web Conference WWW10, pages 285-295 (Hong Kong, 2001), which is incorporated herein by reference.

Collaborative filtering (CF) requires expensive computations that grow polynomially with the number of users and items in the database. Papagelis et al. propose a method for addressing this scalability problem in “Incremental Collaborative Filtering for Highly-Scalable Recommendation Algorithms,” 15th International Symposium on Methodologies for Intelligent Systems ISMIS 2005 (Saratoga Springs, N.Y., 2005), which is incorporated herein by reference. The method is based on incremental updates of user-to-user similarities and is said to provide recommendations orders of magnitude faster than classic CF.

### SUMMARY OF THE INVENTION

Embodiments of the present invention that are described hereinbelow provide efficient methods and systems for collaborative filtering. These methods are described in the specific context of targeted advertising, but they may similarly be used in other interactive on-line applications.

There is therefore provided, in accordance with an embodiment of the present invention, a method for content delivery, including obtaining responses from a first plurality of users to a second plurality of items of content that were delivered to the users over a communication network. For each item, a respective vector is created corresponding to the responses of the users to the item. Distances are computed between the items responsively to the vectors. A first item is selected for delivery to a given user based on a previous response of the given user to a second item and to a distance computed between the first and second items responsively to the vectors. Following the delivery of the first item and receiving a response to the first item from the given user, the distances computed between the items are updated based on the response to the first item. The updated distances are applied in selecting a further item for delivery to another user.

In a disclosed embodiment, updating the distances includes computing an increment to a prior distance that was computed before the delivery of the first item to the given user, and applying the increment to the prior distance in order to find a new distance. Typically, computing the increment includes calculating changes in the vector corresponding to the first item without computation over the elements of the vector corresponding to the second item.

In some embodiments, selecting the first item includes selecting an advertisement for transmission over a wireless network to a mobile communication device operated by the given user, and receiving the response includes determining whether the user interacted with a hyperlink in the advertisement.

In disclosed embodiments, selecting the first item includes computing, based on the distances, a likelihood that the given user will return a positive response to the first item, and choosing the first item responsively to the likelihood. Computing the likelihood may include weighting the distances based on an age of the responses used in computing the distances. Additionally or alternatively, obtaining the responses may include delivering at least one of the items to at least some of the users multiple times, including at least first and second times, and creating the respective vector may include creating first and second vectors corresponding respectively to the responses of the users to the first and second times that the at least one of the items was presented to them.

There is also provided, in accordance with an embodiment of the present invention, apparatus for content delivery, including a memory, coupled to store responses from a first plurality of users to a second plurality of items of content that were delivered to the users over a communication network. A processor is coupled to the memory and is configured to create, for each item, a respective vector corresponding to the responses of the users to the item, to compute distances between the items responsively to the vectors, to select a first item for delivery to a given user based on a previous response of the given user to a second item and to a distance computed between the first and second items responsively to the vectors. The processor is configured, upon receiving a response to the first item from the given user following the delivery of the first item, to update the distances computed between the items based on the response to the first item, and to apply the updated distances in selecting a further item for delivery to another user.

There is additionally provided, in accordance with an embodiment of the present invention, a computer software product, including a computer-readable medium in which program instructions are stored. The instructions, when read by a computer, cause the computer to store responses from a first plurality of users to a second plurality of items of content that were delivered to the users over a communication network, to create, for each item, a respective vector corresponding to the responses of the users to the item, to compute distances between the items responsively to the vectors, to select a first item for delivery to a given user based on a previous response of the given user to a second item and to a distance computed between the first and second items responsively to the vectors. The instructions cause the computer, upon receiving a response to the first item from the given user following the delivery of the first item, to update the distances computed between the items based on the response to the first item, and to apply the updated distances in selecting a further item for delivery to another user.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for mobile content distribution, in accordance with an embodiment of the present invention; and

FIG. 2 is a flow chart that schematically illustrates a method for distribution of advertisements based on incremental collaborative filtering, in accordance with an embodiment of the present invention.

### DETAILED DESCRIPTION OF EMBODIMENTS

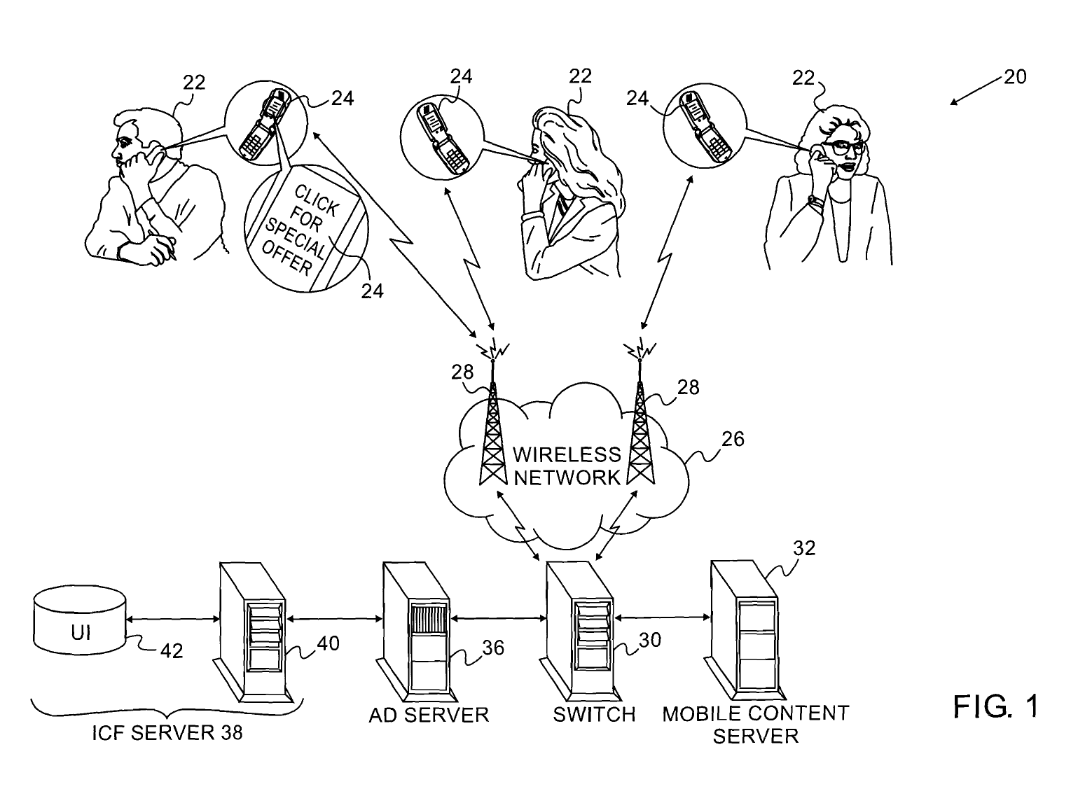

FIG. 1 is a block diagram that schematically illustrates of a communication system 20, in accordance with an embodiment of the present invention. Users 22 operate respective mobile communication devices 24, such as digital cellular telephones, wireless-enabled personal digital assistants (PDAs), and other wireless-enabled computing devices. Mobile communication devices 24 are configured in hardware and/or software to receive and present items of content, such as images, video, audio, and/or text. Communication devices 24 are identified by respective unique identifiers, such as MSISDNs in GSM-based cellular networks, usernames or cookies in Web-based applications, or any other suitable subscriber identifier. Alternatively or additionally, although the pictured embodiment relates specifically to advertising via mobile communications, the methods described hereinbelow may similarly be applied in delivering targeted content of substantially any type to computing and multimedia devices over both wireless and wired networks.

Devices 24 communicate over a wireless network 26, which comprises one or more base stations 28. A mobile content server 32, which comprises at least one processor and an interface, generates content, comprising images, video, audio, text, and/or other data, and sends the content to a switch 30, which routes the content to devices 24 via network 26.

At least some of the content that content server 32 generates contains intervals in which promotional content items, such as advertisements, may be inserted. An ad server 36 is invoked to supply these content items in the appropriate intervals. The intervals may be before, after or within the content provided by server 32 (in which case advertisements may also be inserted over some picture space in the content). The ad server receives an indication of the identity of the device to which the item is to be delivered. It uses this indication together with a recommendation provided by an incremental collaborative filtering (ICF) server 38 in order to select an item that is likely to engender a positive response from the user of the device. Some or all of the content items include user controls, such as hyperlinks, with which users 22 can interact in order to respond to the items. Such interaction (including activation and/or selection of the hyperlink) may take place by any suitable method that is known in the art, and is referred to herein for convenience as “clicking” on the item.

ICF server 38 derives its recommendation by processing previous responses of users 22. For this purpose, when one of the users responds to a given content item, switch 30 routes the response to the ICF server, which performs ICF processing functions that are described in detail hereinbelow. ICF server 38 in the pictured embodiment comprises at least one processor 40 and a memory 42 for storing user response data. Processor 40 typically comprises a general-purpose computer, which is programmed in software to carry out the response processing functions that are described below. This software may be provided in electronic form, over a network, for example, or it may, alternatively or additionally, be stored on tangible storage media, such as optical, magnetic or electronic memory media. Alternatively, some or all of the functions of the ICF server 38 may be implemented using dedicated or programmable hardware circuits. Although ICF server 38 is shown and described, for the sake of clarity, as a separate, stand-alone unit, the functions of the ICF server may alternatively be integrated into other elements of system 20, such as switch 30 or server 36.

ICF server 38 processes the user response data in order to create a User-Item (UI) matrix in memory 42, also referred to as a similarity matrix. Each of the columns of the matrix is a vector that tabulates the responses of the users to a particular item. For example, Table I below shows a simple UI matrix for five users and five items. Assuming the items offer users a binary choice (click or ignore), each UI cell can have three modes:
1. Empty—The item was not introduced yet to that user.
2. 0—The item was presented to the user and the user did not respond (no click).
3. 1—The item was presented to the user and the user responded (clicked).

TABLE I
UI MATRIX EXAMPLE

| | Item 1 | Item 2 | Item 3 | Item 4 | Item 5 |
|---|---|---|---|---|---|
| User 1 | 1 | 1 | 0 | | |
| User 2 | 0 | 0 | 1 | 0 | |
| User 3 | 1 | 1 | 0 | 1 | 1 |
| User 4 | 0 | 0 | 1 | 0 | |
| User 5 | ? | 1 | 0 | | |

In this example, ICF server 38 is to select an item to deliver to User 5 by predicting the item or items to which this user is likely to give a positive response (click).

The prediction process is based on extracting similarities between the columns (item vectors) of the UI matrix. These similarities can be expressed in terms of distances between the item vectors, wherein the smaller the distance, the greater the similarity. Two items are considered similar when many users co-rate both items. For mobile advertising applications, such as in system 20, there are typically many users and a relatively small number of items (such as advertisements). Therefore the UI matrix is composed of a relatively small number of long columns.

In the example shown in Table I, server 38 is called upon to predict whether user 5 will like item 1. Because item 1 and item 2 have similar item vectors, and user 5 has clicked on item 2, it can be predicted will probably click on item 1, as well. On the other hand, the item vector of item 3 is inverse to that of item 1.

Therefore, if user 5 did not like item 3, he will probably like item 1 (although this sort of prediction, based on large distance between vectors, is typically less reliable than prediction based on small distance, such as between items 1 and 2). There is also some similarity between item 4 and item 1, but the response of user 5 to item 4 is not yet known. Similarly, since there is only one cell in common between the item vectors of item 1 and item 5, there is not yet enough information to measure the similarity between these items.

Although distances can be inferred visually in the simple example of Table I, in practice processor 40 computes a quantitative distance measure in order to assess the similarity between item vectors. Small distance corresponds to close similarity, and vice versa. These distances are then used in predicting user responses to new items. In some embodiments, the processor computes a prediction value \hat{R}ᵤ_{ₐ}ᵢ_{ₐ} (indicating the likelihood that user uₐ will respond positively to item iₐ) based on the Pearson distance Simᵢ_{ₓ}ᵢ_{_{y}} between the item vectors. These factors are defined as follows:

$$\begin{matrix}{{R}^{⋒}}_{{u}_{a} {i}_{a}} = {\overline{R}}_{{i}_{a}} + \frac{{\sum }_{k = 1}^{{N}_{i}} ( {R}_{{u}_{a} {i}_{k}} - {\overline{R}}_{{i}_{k}} ) \cdot {Sim}_{{i}_{a} {i}_{k}}}{{\sum }_{k = 1}^{{N}_{i}} abs ( {Sim}_{{i}_{a} {i}_{k}} )} & ( 1 ) \\ {Sim}_{{i}_{x} {i}_{y}} = \frac{{\sum }_{n = 1}^{{N}_{u}} ( {R}_{{u}_{n} {i}_{x}} - {\overline{R}}_{{i}_{x}} ) \cdot ( {R}_{{u}_{n} {i}_{y}} - {\overline{R}}_{{i}_{y}} )}{\sqrt{{\sum }_{n = 1}^{{N}_{u}} {( {R}_{{u}_{n} {i}_{x}} - {\overline{R}}_{{i}_{x}} )}^{2} \cdot {\sum }_{n = 1}^{{N}_{u}} {( {R}_{{u}_{n} {i}_{y}} - {\overline{R}}_{{i}_{y}} )}^{2}}} & ( 2 )\end{matrix}$$

In the above equations, Rᵤ_{ₐ}ᵢ_{ₐ} is the actual response that user uₐ gave to item iₐ (1 or 0 in the present binary example), while R̅ᵢ_{ₐ} is the average response for item iₐ. In equation (2), the distance calculation Simᵢ_{ₓ}ᵢ_{_{y}} between items iₓ and i_{y} includes only users who rated both items (and the sums are over Nᵤ such users, as explained further in the Appendix). Nᵢ is the number of items used in the prediction calculation (either all the available items or a certain subset). Alternatively, other distance measures (such as cosine distance) and prediction formulas may be used. When there are several candidate items for delivery to user uₐ, server 38 typically selects the item with the highest prediction value.

Prediction calculations over a large user base are computation-intensive, particularly if the distance (similarity) values must be updated each time. For example, assuming that Nᵢ˜200 and Nᵤ˜10⁶, a direct calculation of a single prediction requires about 6*10⁸ multiplications and 1.4*10⁹ additions. This computational burden limits the number of predictions that server 38 can perform per second, which thus limits the number of targeted advertisements that can be delivered in system 20.

In order to overcome this problem, server 38 uses an incremental method to update the distance measures each time new data is added to the UI matrix. In other words, the server applies item-based ICF to update each Simᵢ_{ₓ}ᵢ_{_{y}} value by incrementing its previous value, without completely recomputing equation (2) over the entire updated UI matrix. The server then uses the updated distance measures in selecting the subsequent content items for delivery.

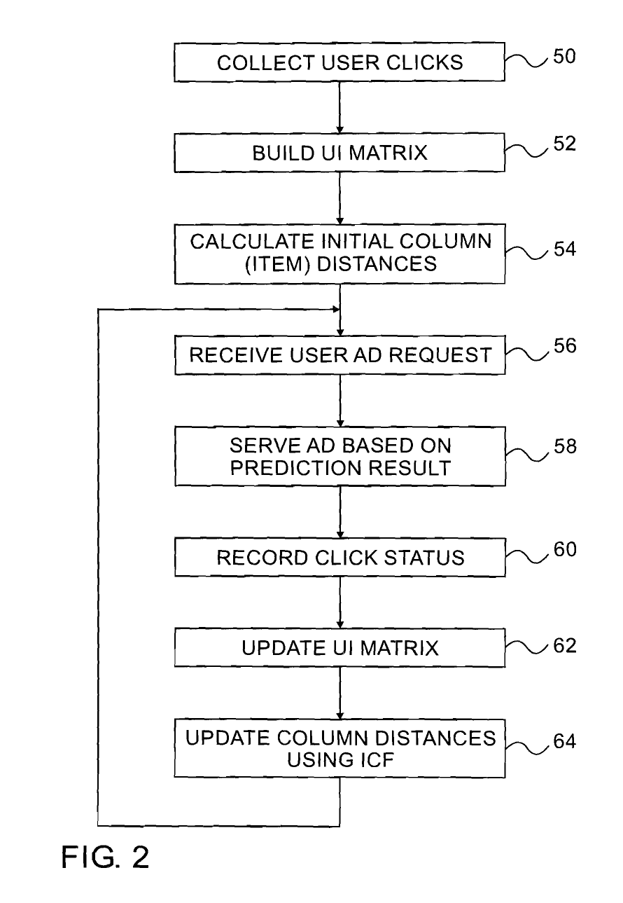

FIG. 2 is a flow chart that schematically illustrates a method for distribution of content items based on ICF, in accordance with an embodiment of the present invention. The method is described hereinbelow, for the sake of clarity and convenience, with reference to the mobile advertising system that is shown in FIG. 1, but the principles of this method may likewise be applied in targeted distribution of items of other types, in both wireless and wired network environments.

ICF server 38 collects user responses to content items delivered by ad server 36 to devices 24, at a click collection step 50. The ICF server records both positive responses (“clicks”) and negative responses (item displayed with no user click) in memory 42. Processor 40 arranges the responses in a UI matrix, as defined above, in a UI building step 52. Once a sufficient number of responses has accumulated, processor 40 computes initial distance values between the item vectors (i.e., between the columns of the UI matrix), at a distance calculation step 54. For this purpose, the processor may use the distance measure defined above in equation (2), or another suitable distance measure. Typically, a distance measure between two given items is considered to be valid only if at least a certain minimum number of users (for example, 100 users) have responded, positively or negatively, to both items.

Ad server 36 receives new requests to deliver a content item to a given user 22 via the respective device 24, at an ad request step 56. The ad server asks ICF server 38 to provide a recommendation in response to each request, or at least some of the requests. In order to make the recommendation, processor 40 computes prediction values \hat{R}ᵤ_{ₐ}ᵢ_{ₐ} for the given user with respect to one or more of the content items that have not yet been delivered to the user, using equation (1) and the current distance values Simᵢ_{ₓ}ᵢ_{_{y}}. Typically, the prediction will be considered valid only if at least a certain minimum number of the component distance values (for example, five distance values) are available.

ICF server 38 then recommends to ad server 36 a content item with a high prediction value—either the highest value among the available items or at least a value above a certain threshold. For example, processor may check whether \hat{R}ᵤ_{ₐ}ᵢ_{ₐ}> R̅ᵢ_{ₐ}, or equivalently may check whether the deviation from the mean component Δᵤ_{ₐ}ᵢ_{ₐ} is positive:

$${Δ}_{{u}_{a} {i}_{a}} = \frac{{\sum }_{k = 1}^{{N}_{i}} ( {R}_{{u}_{a} {i}_{k}} - {\overline{R}}_{{i}_{k}} ) \cdot {Sim}_{{i}_{a} {i}_{k}}}{{\sum }_{k = 1}^{{N}_{i}} abs ( {Sim}_{{i}_{a} {i}_{k}} )} > 0$$

When there are a number of items to choose from, processor 40 may produce a sorted listed of candidates according to the value of Δᵤ_{ₐ}ᵢ_{ₐ}, from most favorite to less favorite. Usually the ICF server will recommend a content item that has not yet been delivered to the user in question, although in some cases content items may be repeated. Ad server 36 then delivers the recommended item to the user, at an ad delivery step 58.

After the content item has been delivered to the user, switch 30 reports the user response to ICF server 38, at a status recording step 60. The server updates the UI matrix with the response data, at a UI update step 62. For example, the server may enter a “1” or “0” in the corresponding cell of the matrix, depending on whether or not the user clicked on the link in the advertisement that was presented to him or her. The server may, from time to time, use the data in the UI matrix to completely recalculate the column distance values, as it did at step 54, in order to eliminate accumulated errors due to the incremental calculations.

In general, however, processor 40 updates the column distances incrementally, at a distance update step 64. The incremental computations take into account the new response value and the change it causes in the corresponding column average, while avoiding recomputation of sums and products over the entire UI matrix. For this purpose, each of the initially-calculated distance values can be framed parametrically as follows:

$$\begin{matrix}{Sim}_{{i}_{x} {i}_{y}} = \frac{{\sum }_{n = 1}^{{N}_{u}} ( {R}_{{u}_{n} {i}_{x}} - {\overline{R}}_{{i}_{x}} ) \cdot ( {R}_{{u}_{n} {i}_{y}} - {\overline{R}}_{{i}_{y}} )}{\sqrt{{\sum }_{n = 1}^{{N}_{u}} {( {R}_{{u}_{n} {i}_{x}} - {\overline{R}}_{{i}_{x}} )}^{2} \cdot {\sum }_{n = 1}^{{N}_{u}} {( {R}_{{u}_{n} {i}_{y}} - {\overline{R}}_{{i}_{y}} )}^{2}}} \\ = \frac{{B}_{x , y}}{\sqrt{{C}_{x , y} \cdot {D}_{x , y}}}\end{matrix} \qquad ( 3 )$$

The distance between any pair of columns (items) x and y can be derived from the corresponding elements of the matrices B, C and D. Each time a user response is received, the affected elements of the matrices are updated incrementally:

B′=B+e

C′=C+f

D′=D+g

The values of the increments to the elements of e, f and g depend on the specific circumstances that apply to each matrix element (for example, which items have already been delivered to and responded to—positively or negatively—by the user in question). Detailed formulas are presented below in an Appendix.

ICF server 38 uses the updated distances computed at step 64, based on equations (3) and (4), in deciding what items to recommend for delivery to other users in subsequent passes through steps 56-64. In an experiment conducted on a standard Pentium-based computer, the inventors found that they were able to generate approximately 50,000 recommendations (prediction operations) per second in this manner.

Although the formulas presented above give equal weights to all user responses, server 38 may alternatively take into account temporal factors and, for example, give greater weight to more recent responses. Responses to items delivered in the distant past may be considered obsolete and eliminated. For this purpose, the corresponding columns may be removed from the UI matrix and the distances recalculated over the remaining items (according to the procedure at step 54).

For the remaining items, processor 40 may apply an aging factor, which will tend to give a higher weight to similarity with recently-introduced items. For this purpose, equation (1) may be reformulated as follows:

$${{R}^{⋒}}_{{u}_{a} {i}_{a}} = {\overline{R}}_{{i}_{a}} + \frac{{\sum }_{k = 1}^{{N}_{i}} ( {R}_{{u}_{a} {i}_{k}} - {\overline{R}}_{{i}_{k}} ) \cdot {w}_{k} \cdot {Sim}_{{i}_{a} {i}_{k}}}{{\sum }_{k = 1}^{{N}_{i}} {w}_{k} \cdot abs ( {Sim}_{{i}_{a} {i}_{k}} )}$$

In this formula, wₖ=e^{-λ·T}^{ₖ}, λ is a constant aging factor, and Tₖ is the elapsed time (in months, for example) since item number k was introduced. Thus, if λ=0.1, the weight will be reduced to about 0.5 for items that are six months old.

The methods presented above are designed to predict user response to newly-introduced items on the assumption that any given item is presented to a user only once. In some cases, however, an item may be delivered several times to the same user, during an advertising campaign, for example. This situation may be handled simply by modifying the above methods in a number of ways, for example:
Only the first response counts, and subsequent responses to the same item are ignored.
Only the last response counts, and earlier responses are ignored.

Alternatively, for more accurate prediction, each repeat delivery of a given item can be treated as a new “pseudo-item,” with its own column in the UI matrix. The matrix may be processed in various ways in order to predict user responses to a given item, including:
The processor may use the entire UI matrix, including all columns, in the calculation.
The processor may consider only the subset of columns corresponding to the given item (for initial and repeat deliveries).

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

### Appendix—Calculation OF ICF Increments

The section that follows presents the formulas for calculation of the distance increments e, f and g, as defined above in equation (4). The formulas vary depending on circumstances pertaining to the user in question and the different items in the UI matrix. In each case, the increments are computed based on the changes that have occurred in the specific columns (vectors) corresponding to the items in question without computation over all elements in the columns as required by equation (2).

Case 1—In this case, an increment for updating Simᵢ_{ₐ}ᵢ_{_{y}} is to be calculated after a user uₐ has responded to item iₐ for the first time, without having yet responded to item i_{y}. Here the increments in equation (4) result from dRᵢ_{ₐ}, i .e . , the change in R̅ᵢ_{ₐ}. In the formulas below, N denotes the number of users who have responded to both of items iₐ and i_{y}, and R_{S1}, R_{S2} denote the sums of the UI matrix entries in the columns for items iₐ and i_{y}, respectively. (Thus, the sums are taken only over users who responded to both items. The symbol “h” is used to index members of this subset of users.)

$$\begin{matrix}\begin{matrix}{B}^{′} = {\sum }_{h = 1}^{N} ( {R}_{{u}_{h} {i}_{a}} - {\overline{R}}_{{i}_{a}} - {dR}_{{i}_{a}} ) \cdot ( {R}_{{u}_{h} {i}_{y}} - {\overline{R}}_{{i}_{y}} ) \\ = {\sum }_{h = 1}^{N} ( {R}_{{u}_{h} {i}_{a}} - {\overline{R}}_{{i}_{a}} ) \cdot ( {R}_{{u}_{h} {i}_{y}} - {\overline{R}}_{{i}_{y}} ) - \\ {\sum }_{h = 1}^{N} {dR}_{{i}_{a}} \cdot ( {R}_{{u}_{h} {i}_{y}} - {\overline{R}}_{{i}_{y}} ) \\ = B - {\sum }_{h = 1}^{N} {dR}_{{i}_{a}} \cdot ( {R}_{{u}_{h} {i}_{y}} - {\overline{R}}_{{i}_{y}} )\end{matrix} & \\ \begin{matrix}{C}^{′} = {\sum }_{h = 1}^{N} {( {R}_{{u}_{h} {i}_{a}} - {\overline{R}}_{{i}_{a}} - {dR}_{{i}_{a}} )}^{2} \\ = {\sum }_{h = 1}^{N} {( {R}_{{u}_{h} {i}_{a}} - {\overline{R}}_{{i}_{a}} )}^{2} - 2 \cdot {dR}_{{i}_{a}} \cdot {\sum }_{h = 1}^{N} ( {R}_{{u}_{h} {i}_{a}} - {\overline{R}}_{a} ) + \\ {\sum }_{h = 1}^{N} {dR}_{{i}_{a}}^{2} \\ = C - 2 \cdot {dR}_{{i}_{a}} \cdot {\sum }_{h = 1}^{N} ( {R}_{{u}_{h} {i}_{a}} - {\overline{R}}_{{i}_{a}} ) + {\sum }_{h = 1}^{N} {dR}_{{i}_{a}}^{2}\end{matrix} & \\ {D}^{′} = {\sum }_{h = 1}^{N} {( {R}_{{u}_{h} {i}_{y}} - {\overline{R}}_{{i}_{y}} )}^{2} = D & \end{matrix}$$

The incremental steps are then given by:

$$\begin{matrix}\begin{matrix}e = - {\sum }_{h = 1}^{N} {dR}_{{i}_{a}} \cdot ( {R}_{{u}_{h} {i}_{y}} - {\overline{R}}_{{i}_{y}} ) \\ = - {dR}_{{i}_{a}} \cdot ( {R}_{S 2} + {\overline{R}}_{{i}_{y}} \cdot N )\end{matrix} & \\ \begin{matrix}f = - 2 \cdot {dR}_{{i}_{a}} \cdot {\sum }_{h = 1}^{N} ( {R}_{{u}_{h} {i}_{a}} - {\overline{R}}_{{i}_{a}} ) + {\sum }_{h = 1}^{N} {dR}_{{i}_{a}}^{2} \\ = - 2 \cdot {dR}_{{i}_{a}} \cdot ( {R}_{S 1} - {\overline{R}}_{{i}_{a}} \cdot N ) + {dR}_{{i}_{a}}^{2} \cdot N\end{matrix} & \\ g = 0 & \end{matrix}$$

Since only the entries in the column belonging to iₐ have changed, calculating the increments to the distance values requires only that processor 40 update sums and differences over this column, followed by a few multiplications. The same simplification occurs in the other cases listed below, as well.

Case 2—In this case, the increment for updating Simᵢ_{ₐ}ᵢ_{_{y}} is to be calculated after user uₐ has responded to item iₐ for the first time, after having previously responded to item i_{y}, as well. Here the increment to Simᵢ_{ₐ}ᵢ_{_{y}} results both from the change in R̅ᵢ_{ₐ} and from an additional element in the sums due to Rᵤ_{ₐ}ᵢₐ.

$$\begin{matrix}\begin{matrix}{B}^{′} = {\sum }_{h = 1}^{N} ( {R}_{{u}_{h} {i}_{a}} - {\overline{R}}_{{i}_{a}} - {dR}_{{i}_{a}} ) \cdot ( {R}_{{u}_{h} {i}_{y}} - {\overline{R}}_{{i}_{y}} ) + \\ ( {R}_{{u}_{a} {i}_{a}} - {\overline{R}}_{{i}_{a}} - {dR}_{{i}_{a}} ) \cdot ( {R}_{{u}_{a} {i}_{y}} - {\overline{R}}_{{i}_{y}} ) \\ = {\sum }_{h = 1}^{N} ( {R}_{{u}_{h} {i}_{a}} - {\overline{R}}_{{i}_{a}} ) \cdot ( {R}_{{u}_{h} {i}_{y}} - {\overline{R}}_{{i}_{y}} ) - \\ {\sum }_{h = 1}^{N} {dR}_{{i}_{a}} \cdot ( {R}_{{u}_{h} {i}_{y}} - {\overline{R}}_{{i}_{y}} ) + ( {R}_{{u}_{a} {i}_{a}} - {\overline{R}}_{{i}_{a}} - {dR}_{{i}_{a}} ) \cdot ( {R}_{{u}_{a} {i}_{y}} - {\overline{R}}_{{i}_{y}} ) \\ = B - {\sum }_{h = 1}^{N} {dR}_{{i}_{a}} \cdot ( {R}_{{u}_{h} {i}_{y}} - {\overline{R}}_{{i}_{y}} ) + ( {R}_{{u}_{a} {i}_{a}} - {\overline{R}}_{{i}_{a}} - {dR}_{{i}_{a}} ) \cdot ( {R}_{{u}_{a} {i}_{y}} - {\overline{R}}_{{i}_{y}} )\end{matrix} \\ \begin{matrix}{C}^{′} = {\sum }_{h = 1}^{N} {( {R}_{{u}_{h} {i}_{a}} - {\overline{R}}_{{i}_{a}} - {dR}_{{i}_{a}} )}^{2} + {( {R}_{{u}_{a} {i}_{a}} - {\overline{R}}_{{i}_{a}} - {dR}_{{i}_{a}} )}^{2} \\ = {\sum }_{h = 1}^{N} {( {R}_{{u}_{h} {i}_{a}} - {\overline{R}}_{{i}_{a}} )}^{2} - 2 \cdot {dR}_{{i}_{a}} \cdot {\sum }_{h = 1}^{N} ( {R}_{{u}_{h} {i}_{a}} - {\overline{R}}_{{i}_{a}} ) + \\ {\sum }_{h = 1}^{N} {dR}_{{i}_{a}}^{2} + {( {R}_{{u}_{a} {i}_{a}} - {\overline{R}}_{{i}_{a}} - {dR}_{{i}_{a}} )}^{2} \\ = C - 2 \cdot {dR}_{{i}_{a}} \cdot {\sum }_{h = 1}^{N} ( {R}_{{u}_{h} {i}_{a}} - {\overline{R}}_{{i}_{a}} ) + {\sum }_{h = 1}^{N} {dR}_{{i}_{a}}^{2} + \\ {( {R}_{{u}_{a} {i}_{a}} - {\overline{R}}_{{i}_{a}} - {dR}_{{i}_{a}} )}^{2}\end{matrix} \\ \begin{matrix}{D}^{′} = {\sum }_{h = 1}^{N} {( {R}_{{u}_{a} {i}_{y}} - {\overline{R}}_{{i}_{y}} )}^{2} + {( {R}_{{u}_{a} {i}_{y}} - {\overline{R}}_{{i}_{y}} )}^{2} \\ = D + {( {R}_{{u}_{h} {i}_{y}} - {\overline{R}}_{{i}_{y}} )}^{2}\end{matrix}\end{matrix}$$

The incremental steps are given by:

$$\begin{matrix}\begin{matrix}e = - {\sum }_{h = 1}^{N} {dR}_{{i}_{a}} \cdot ( {R}_{{u}_{h} {i}_{y}} - {\overline{R}}_{{i}_{y}} ) + ( {R}_{{u}_{a} {i}_{a}} - {\overline{R}}_{{i}_{a}} - {dR}_{{i}_{a}} ) \cdot ( {R}_{{u}_{a} {i}_{y}} - {\overline{R}}_{{i}_{y}} ) \\ = - {dR}_{{i}_{a}} \cdot ( {R}_{S 2} + {\overline{R}}_{{i}_{y}} \cdot N ) + ( {R}_{{u}_{a} {i}_{a}} - {\overline{R}}_{{i}_{a}} - {dR}_{{i}_{a}} ) \cdot ( {R}_{{u}_{a} {i}_{y}} - {\overline{R}}_{{i}_{y}} )\end{matrix} & \\ \begin{matrix}f = - 2 \cdot {dR}_{{i}_{a}} \cdot {\sum }_{h = 1}^{N} ( {R}_{{u}_{h} {i}_{a}} - {\overline{R}}_{{i}_{a}} ) + {\sum }_{h = 1}^{N} {dR}_{{i}_{a}}^{2} + {( {R}_{{u}_{a} {i}_{a}} - {\overline{R}}_{{i}_{a}} - {dR}_{{i}_{a}} )}^{2} \\ = - 2 \cdot {dR}_{{i}_{a}} \cdot ( {R}_{S 1} - {\overline{R}}_{{i}_{a}} \cdot N ) + {dR}_{{i}_{a}}^{2} \cdot N + {( {R}_{{u}_{a} {i}_{a}} - {\overline{R}}_{{i}_{a}} - {dR}_{{i}_{a}} )}^{2}\end{matrix} & \\ g = {( {R}_{{u}_{a} {i}_{y}} - {\overline{R}}_{{i}_{y}} )}^{2} & \end{matrix}$$

Case 3—User uₐ has updated a previous response to item iₐ, but has not yet entered any response to item i_{y}. Here the difference results from the change in R̅ᵢ_{ₐ}.

$$\begin{matrix}\begin{matrix}{B}^{′} = {\sum }_{h = 1}^{N} ( {R}_{{u}_{h} {i}_{a}} - {\overline{R}}_{{i}_{a}} - {dR}_{{i}_{a}} ) \cdot ( {R}_{{u}_{h} {i}_{y}} - {\overline{R}}_{{i}_{y}} ) \\ = {\sum }_{h = 1}^{N} ( {R}_{{u}_{h} {i}_{a}} - {\overline{R}}_{{i}_{a}} ) \cdot ( {R}_{{u}_{h} {i}_{y}} - {\overline{R}}_{{i}_{y}} ) - \\ {\sum }_{h = 1}^{N} {dR}_{{i}_{a}} \cdot ( {R}_{{u}_{h} {i}_{y}} - {\overline{R}}_{{i}_{y}} ) \\ = B - {\sum }_{h = 1}^{N} {dR}_{{i}_{a}} \cdot ( {R}_{{u}_{h} {i}_{y}} - {\overline{R}}_{{i}_{y}} )\end{matrix} \\ \begin{matrix}{C}^{′} = {\sum }_{h = 1}^{N} {( {R}_{{u}_{h} {i}_{a}} - {\overline{R}}_{{i}_{a}} - {dR}_{{i}_{a}} )}^{2} \\ = {\sum }_{h = 1}^{N} {( {R}_{{u}_{h} {i}_{a}} - {\overline{R}}_{{i}_{a}} )}^{2} - 2 \cdot {dR}_{{i}_{a}} \cdot {\sum }_{h = 1}^{N} ( {R}_{{u}_{h} {i}_{a}} - {\overline{R}}_{{i}_{a}} ) + \\ {\sum }_{h = 1}^{N} {dR}_{{i}_{a}}^{2} \\ = C - 2 \cdot {dR}_{{i}_{a}} \cdot {\sum }_{h = 1}^{N} ( {R}_{{u}_{h} {i}_{a}} - {\overline{R}}_{{i}_{a}} ) + {\sum }_{h = 1}^{N} {dR}_{{i}_{a}}^{2}\end{matrix} \\ \begin{matrix}{D}^{′} = {\sum }_{h = 1}^{N} {( {R}_{{u}_{h} {i}_{y}} - {\overline{R}}_{{i}_{y}} )}^{2} \\ = D\end{matrix}\end{matrix}$$

The incremental steps are given by:

$$\begin{matrix}\begin{matrix}e = - {\sum }_{h = 1}^{N} {dR}_{{i}_{a}} \cdot ( {R}_{{u}_{h} {i}_{y}} - {\overline{R}}_{{i}_{y}} ) \\ = - {dR}_{{i}_{a}} \cdot ( {R}_{S 2} + {\overline{R}}_{{i}_{y}} \cdot N )\end{matrix} & \\ \begin{matrix}f = - 2 \cdot {dR}_{{i}_{a}} \cdot {\sum }_{h = 1}^{N} ( {R}_{{u}_{h} {i}_{a}} - {\overline{R}}_{{i}_{a}} ) + {\sum }_{h = 1}^{N} {dR}_{{i}_{a}}^{2} \\ = - 2 \cdot {dR}_{{i}_{a}} \cdot ( {R}_{S 1} - {\overline{R}}_{{i}_{a}} \cdot N ) + {dR}_{{i}_{a}}^{2} \cdot N\end{matrix} & \\ g = 0 & \end{matrix}$$

Case 4–User uₐ has updated his previous response to item iₐ, and user uₐ has also responded to item i_{y}. Here the difference results both from the change in R̅ᵢ_{ₐ} and from the change in the response, dRᵤ_{ₐ}ᵢ_{ₐ}.

$$\begin{matrix}\begin{matrix}{B}^{′} = {\sum }_{h = 1}^{N} ( {R}_{{u}_{h} {i}_{a}} - {\overline{R}}_{{i}_{a}} - {dR}_{{i}_{a}} ) \cdot ( {R}_{{u}_{h} {i}_{y}} - {\overline{R}}_{{i}_{y}} ) + \\ ( {R}_{{u}_{a} {i}_{a}} + {dR}_{{u}_{a} {i}_{a}} - {\overline{R}}_{{i}_{a}} - {dR}_{{i}_{a}} ) \cdot ( {R}_{{u}_{a} {i}_{y}} - {\overline{R}}_{{i}_{y}} ) - \\ ( {R}_{{u}_{a} {i}_{a}} - {\overline{R}}_{{i}_{a}} - {dR}_{{i}_{a}} ) \cdot ( {R}_{{u}_{a} {i}_{y}} - {\overline{R}}_{{i}_{y}} ) \\ = {\sum }_{h = 1}^{N} ( {R}_{{u}_{h} {i}_{a}} - {\overline{R}}_{{i}_{a}} ) \cdot ( {R}_{{u}_{h} {i}_{y}} - {\overline{R}}_{{i}_{y}} ) - \\ {\sum }_{h = 1}^{N} {dR}_{{i}_{a}} \cdot ( {R}_{{u}_{h} {i}_{y}} - {\overline{R}}_{{i}_{y}} ) + {dR}_{{u}_{a} {i}_{a}} \cdot ( {R}_{{u}_{a} {i}_{y}} - {\overline{R}}_{{i}_{y}} ) \\ = B - {\sum }_{h = 1}^{N} {dR}_{{i}_{a}} \cdot ( {R}_{{u}_{h} {i}_{y}} - {\overline{R}}_{{i}_{y}} ) + {dR}_{{u}_{a} {i}_{a}} \cdot ( {R}_{{u}_{a} {i}_{y}} - {\overline{R}}_{{i}_{y}} )\end{matrix} \\ \begin{matrix}{C}^{′} = {\sum }_{h = 1}^{N} {( {R}_{{u}_{h} {i}_{a}} - {\overline{R}}_{{i}_{a}} - {dR}_{{i}_{a}} )}^{2} + {( {R}_{{u}_{a} {i}_{a}} - {\overline{R}}_{{i}_{a}} - {dR}_{{i}_{a}} + {dR}_{{u}_{a} {i}_{a}} )}^{2} - \\ {( {R}_{{u}_{a} {i}_{a}} - {\overline{R}}_{{i}_{a}} - {dR}_{{i}_{a}} )}^{2} \\ = {\sum }_{h = 1}^{N} {( {R}_{{u}_{h} {i}_{a}} - {\overline{R}}_{{i}_{a}} )}^{2} - 2 \cdot {dR}_{{i}_{a}} \cdot {\sum }_{h = 1}^{N} ( {R}_{{u}_{h} {i}_{a}} - {\overline{R}}_{{i}_{a}} ) + \\ {\sum }_{h = 1}^{N} {dR}_{{i}_{a}}^{2} + 2 \cdot {dR}_{{u}_{a} {i}_{a}} \cdot ( {R}_{{u}_{a} {i}_{a}} - {\overline{R}}_{{i}_{a}} - {dR}_{{i}_{a}} ) + {dR}_{{u}_{a} {i}_{a}}^{2} \\ = C - 2 \cdot {dR}_{{i}_{a}} \cdot {\sum }_{h = 1}^{N} ( {R}_{{u}_{h} {i}_{a}} - {\overline{R}}_{{i}_{a}} ) + {\sum }_{h = 1}^{N} {dR}_{{i}_{a}}^{2} + 2 \cdot {dR}_{{u}_{a} {i}_{a}} \cdot \\ ( {R}_{{u}_{a} {i}_{a}} - {\overline{R}}_{{i}_{a}} - {dR}_{{i}_{a}} ) + {dR}_{{u}_{a} {i}_{a}}^{2}\end{matrix} \\ \begin{matrix}{D}^{′} = {\sum }_{h = 1}^{N} {( {R}_{{u}_{h} {i}_{y}} - {\overline{R}}_{{i}_{y}} )}^{2} \\ = D\end{matrix}\end{matrix}$$

The incremental steps are given by:

$$\begin{matrix}\begin{matrix}e = - {\sum }_{h = 1}^{N} {dR}_{{i}_{a}} \cdot ( {R}_{{u}_{h} {i}_{y}} - {\overline{R}}_{{i}_{y}} ) + {dR}_{{u}_{a} {i}_{a}} \cdot ( {R}_{{u}_{a} {i}_{y}} - {\overline{R}}_{{i}_{y}} ) \\ = - {dR}_{{i}_{a}} \cdot ( {R}_{S 2} + {\overline{R}}_{{i}_{y}} \cdot N ) + {dR}_{{u}_{a} {i}_{a}} \cdot ( {R}_{{u}_{a} {i}_{y}} - {\overline{R}}_{{i}_{y}} )\end{matrix} & \\ \begin{matrix}f = - 2 \cdot {dR}_{{i}_{a}} \cdot {\sum }_{h = 1}^{N} ( {R}_{{u}_{h} {i}_{a}} - {\overline{R}}_{{i}_{a}} ) + {\sum }_{h = 1}^{N} {dR}_{{i}_{a}}^{2} + 2 \cdot {dR}_{{u}_{a} {i}_{a}} \cdot \\ ( {R}_{{u}_{a} {i}_{a}} - {\overline{R}}_{{i}_{a}} - {dR}_{{i}_{a}} ) + {dR}_{{u}_{a} {i}_{a}}^{2} \\ = - 2 \cdot {dR}_{{i}_{a}} \cdot ( {R}_{S 1} - {\overline{R}}_{{i}_{a}} \cdot N ) + {dR}_{{i}_{a}}^{2} \cdot N + 2 \cdot {dR}_{{u}_{a} {i}_{a}} \cdot \\ ( {R}_{{u}_{a} {i}_{a}} - {\overline{R}}_{{i}_{a}} - {dR}_{{i}_{a}} ) + {dR}_{{u}_{a} {i}_{a}}^{2}\end{matrix} & \\ g = 0 & \end{matrix}$$

1. A method for content delivery, comprising:
obtaining responses from a first plurality of users to a second plurality of items of content that were delivered to the users over a communication network;
for each item, creating a respective vector corresponding to the responses of the users to the item;
computing distances between the items responsively to the vectors;
selecting a first item for delivery to a given user based on a previous response of the given user to a second item and to a distance computed between the first and second items responsively to the vectors;
following the delivery of the first item, receiving a response to the first item from the given user;
updating the distances computed between the items based on the response to the first item; and
applying the updated distances in selecting a further item for delivery to another user.

2. The method according to claim 1, wherein updating the distances comprises computing an increment to a prior distance that was computed before the delivery of the first item to the given user, and applying the increment to the prior distance in order to find a new distance.

3. The method according to claim 2, wherein computing the increment comprises calculating changes in the vector corresponding to the first item without computation over the elements of the vector corresponding to the second item.

4. The method according to claim 1, wherein selecting the first item comprises selecting an advertisement for transmission over a wireless network to a mobile communication device operated by the given user, and wherein receiving the response comprises determining whether the user interacted with a hyperlink in the advertisement.

5. The method according to claim 1, wherein selecting the first item comprises computing, based on the distances, a likelihood that the given user will return a positive response to the first item, and choosing the first item responsively to the likelihood.

6. The method according to claim 5, wherein computing the likelihood comprises weighting the distances based on an age of the responses used in computing the distances.

7. The method according to claim 1, wherein obtaining the responses comprises delivering at least one of the items to at least some of the users multiple times, including at least first and second times, and wherein creating the respective vector comprises creating first and second vectors corresponding respectively to the responses of the users to the first and second times that the at least one of the items was presented to them.

8. Apparatus for content delivery, comprising:
a memory, coupled to store responses from a first plurality of users to a second plurality of items of content that were delivered to the users over a communication network; and
a processor, which is coupled to the memory and is configured to create, for each item, a respective vector corresponding to the responses of the users to the item, to compute distances between the items responsively to the vectors, to select a first item for delivery to a given user based on a previous response of the given user to a second item and to a distance computed between the first and second items responsively to the vectors,
wherein the processor is configured, upon receiving a response to the first item from the given user following the delivery of the first item, to update the distances computed between the items based on the response to the first item, and to apply the updated distances in selecting a further item for delivery to another user.

9. The apparatus according to claim 8, wherein the processor is configured to update the distances by computing an increment to a prior distance that was computed before the delivery of the first item to the given user, and applying the increment to the prior distance in order to find a new distance.

10. The apparatus according to claim 9, wherein the processor is configured to compute the increment by calculating changes in the vector corresponding to the first item without computation over the elements of the vector corresponding to the second item.

11. The apparatus according to claim 8, wherein the items comprise advertisements for transmission over a wireless network to a mobile communication device operated by the given user, and wherein the response comprises an indication of whether the user interacted with a hyperlink in an advertisement transmitted to the given user.

12. The apparatus according to claim 8, wherein the processor is configured to compute, based on the distances, a likelihood that the given user will return a positive response to the first item, and to select the first item responsively to the likelihood.

13. The apparatus according to claim 12, wherein the processor is configured to weight the distances based on an age of the responses used in computing the distances.

14. The apparatus according to claim 8, wherein at least one of the items is delivered to at least some of the users multiple times, including at least first and second times, and wherein creating the processor is configured to create first and second vectors corresponding respectively to the responses of the users to the first and second times that the at least one of the items was presented to them.

15. A computer software product, comprising a computer-readable medium in which program instructions are stored, which instructions, when read by a computer, cause the computer to store responses from a first plurality of users to a second plurality of items of content that were delivered to the users over a communication network, to create, for each item, a respective vector corresponding to the responses of the users to the item, to compute distances between the items responsively to the vectors, to select a first item for delivery to a given user based on a previous response of the given user to a second item and to a distance computed between the first and second items responsively to the vectors,
wherein the instructions cause the computer, upon receiving a response to the first item from the given user following the delivery of the first item, to update the distances computed between the items based on the response to the first item, and to apply the updated distances in selecting a further item for delivery to another user.

16. The product according to claim 15, wherein the instructions cause the computer to update the distances by computing an increment to a prior distance that was computed before the delivery of the first item to the given user, and applying the increment to the prior distance in order to find a new distance.

17. The product according to claim 16, wherein the instructions cause the computer to compute the increment by calculating changes in the vector corresponding to the first item without computation over the elements of the vector corresponding to the second item.

18. The product according to claim 15, wherein the items comprise advertisements for transmission over a wireless network to a mobile communication device operated by the given user, and wherein the response comprises an indication of whether the user interacted with a hyperlink in an advertisement transmitted to the given user.

19. The product according to claim 15, wherein the instructions cause the computer to compute, based on the distances, a likelihood that the given user will return a positive response to the first item, and to select the first item responsively to the likelihood.

20. The product according to claim 19, wherein the instructions cause the computer to weight the distances based on an age of the responses used in computing the distances.

21. The product according to claim 15, wherein at least one of the items is delivered to at least some of the users multiple times, including at least first and second times, and wherein creating the instructions cause the computer to create first and second vectors corresponding respectively to the responses of the users to the first and second times that the at least one of the items was presented to them.
